(19) United States
(12) Patent Application Publication
(10) Pub. No.: US 2014/0280303 A1
(43) Pub. Date: Sep. 18, 2014

(54) REPLACING EQUIVALENT CONTENT ITEMS

(71) Applicant: RHAPSODY INTERNATIONAL INC., Seattle, WA (US)

(72) Inventors: Nishant Jain, Sunnyvale, CA (US); Andrew Craig Wood, San Francisco, CA (US)

(73) Assignee: RHAPSODY INTERNATIONAL INC., Seattle, WA (US)

(21) Appl. No.: 13/838,584

(22) Filed: Mar. 15, 2013

(51) Int. Cl. G06F 17/30

(52) U.S. Cl. CPC G06F 17/30377
USPC 707/769

(57) ABSTRACT

Systems and methods for updating user play lists in a content provider service. A computer system may receive indications of a plurality of content items to be removed from a digital content library of the content provider service. The computer system may query a user database to identify a plurality of user play lists comprising a reference to a first content item selected from the plurality of content items. Each of the plurality of user play lists may be associated with a user of the content provider service. The computer system may identify a second content item that is equivalent to the first content item. The computer system may update at least one user play list selected from the plurality of user play lists to replace references to the first content item with references to the second content item.

### BACKGROUND

This application generally relates to replacing content items with equivalent content items.

A proliferation of content provider services gives users access to all types of digital content including, music, movies, books, etc. Typically, a content provider service obtains license rights to a library of digital content. A user subscribes to the content provider service to receive content items, either individually or bundled together (e.g., by genre) via a stream. Users receive the content items via various different types of user devices including, for example, mobile devices, other computers, network-enabled stereo receivers, etc. Users are charged according to many different types of payment methodologies including, for example, periodic subscription charges, charges by content item, charges by unit time, etc. Traditional search engines and similar tools allow users to search libraries of available content to find content items for viewing, listening and/or downloading.

### DRAWINGS

Various example embodiments are described herein by way of example in conjunction with the following figures, wherein:

FIG. 1 is a block diagram showing one example embodiment of an environment for implementing systems and methods for providing user devices with geographic information relating to content items.

FIG. 2 is a block diagram showing one example embodiment of a playback system in communication with a user device and a content distribution system.

FIG. 3 is a block diagram showing one example embodiment of the master database of the playback system of FIG. 2.

FIG. 4 is a block diagram showing one example embodiment of the user database.

FIG. 5 is a flow chart showing one example embodiment of a process flow that may be performed by the playback system of the environment of FIG. 1 to group equivalent content items.

FIG. 6 is a flow chart showing one example embodiment of a process flow that may be performed by the playback system of the environment of FIG. 1 to compare content items based on their associated characteristics.

FIG. 7 is a diagram showing one example embodiment of a comparison word indicating results of a comparison between a first content item (Track A) and a second content item (Track B).

FIG. 8 is a flow chart showing one example embodiment of a process flow 800 that may be performed by the playback system to compare a set of content items to be grouped (a set of subject content items) to a set of other content items.

FIG. 9 is a flow chart illustrating a process flow that may be performed by the playback system of FIG. 2 to update user play lists to reflect changes to available content items.

FIG. 10 is a flow chart illustrating one example embodiment of a process flow that may be performed by the playback system of FIG. 2 to update user play lists to reflect changes to available content items.

FIG. 11 is a flow chart illustrating one example embodiment of a process flow that may be performed by the playback system of FIG. 2 to update user play lists stored at user devices.

FIG. 12 is a flow chart illustrating one example embodiment of a process flow that may be performed by the playback system of FIG. 2 to respond to a content item request utilizing logical content item identifiers.

FIG. 13 is a flow chart illustrating one example embodiment of a process flow that may be performed by the playback system of FIG. 2 to translate content item ID's to refer to equivalent content items.

### DESCRIPTION

Various example embodiments are directed to systems and methods for identifying equivalent content items including, for example equivalent audio tracks. Due to licensing considerations or other reasons, digital content libraries offered by content provider services often include multiple distinct content items that are equivalent. For example, distinct audio tracks may be or contain versions of the same song. In some instances, the same song may appear on multiple releases (e.g., a single, an original album, a greatest hits album or other compilation, a re-mastered version, etc.). Also, license holders sometimes re-release various albums or audio tracks audio tracks for different reasons, creating multiple equivalent versions of the same content item. Identifying distinct audio tracks, or other content items, that are equivalent can provide various advantages. For example, if a particular content item becomes unavailable (e.g., due to changes in licensing arrangements), the content provider service may provide its users with an alternative, equivalent content item. Also, for example, classifying content items by equivalence may allow content provider services to give access to content items by logical unit, rather than by specific content item, as described herein.

Content items may be described by a plurality of characteristics. For example, an audio track may be described by a digital fingerprint, a track name, an artist, an album, a live flag, an explicit flag, a hash value, a duration, a disk number and/or a sequence number. A video content item, for example, may be described by a digital fingerprint, a name, one or more artists, an explicit flag, a hash value, a duration, etc. It will be appreciated that the precise set of content item characteristics used in any given context may vary and may include fewer than the listed characteristics and/or additional characteristics not shown. Further, various example embodiments are described herein in the context of audio track content items. It will be appreciated, however, that the various systems and methods described herein may be implemented for any type of content item including, for example, video content items, image content items, etc.

A computer system may be utilized to identify equivalent content items based on content item characteristics (e.g., a computer system associated with the content provider service). For example, the computer system may receive a description of a first content item (or other content item). The first content item is then compared to each of a plurality of other content items (e.g., other content items from the digital content library). For each combination of the first content item and one of the other content items, the computer system identifies characteristics, if any, for which the two content items have equivalent values. Equivalence between values for content item characteristics may be determined in any suitable manner and may be different for different characteristics. For example, values for a hash characteristic may be equivalent if they are identical. Values for a digital fingerprint characteristic may be equivalent if they differ by less than a threshold amount. Values for a duration characteristic may be equivalent if they differ by less than a threshold time, etc.

The computer system identifies content items from the plurality of other tracks that are equivalent to the first content item. For example, a track may be considered equivalent to the first content item if it has equivalent values for at least one predetermined pattern of the plurality of content item characteristics. Each of the at least one predetermined patterns represent a combination of content item characteristics for which equivalent values indicate overall track equivalence. Example characteristic patterns are described herein below. In some example embodiments, the computer system may identify content items equivalent to the first content item by filtering results of the comparison in view of the at least one predetermined pattern. Content items from the plurality of other content items having characteristics that do not have one of the predetermined patterns of equivalence with the first track may be filtered out. The first content item and any content items found to be equivalent to the first content item (e.g., the equivalent tracks) may be associated with one another as a group. If one or more of the equivalent tracks are already part of a previously existing group, then the equivalent tracks may be added to the preexisting group.

In various example embodiments, identified equivalent audio tracks or other content items may be utilized in situations where a content provider service removes a content item from its digital content library. Such removals occur for various reasons. For example, a rights holder (e.g., record company or studio) may re-release a content item and request that other versions be removed. Also, for example, license agreements between the content service provider and various rights holders may expire and/or be modified. The removal of content items from the digital content library can inconvenience users. For example, users may have user play lists that reference particular digital content items. User play lists may include any suitable association between a user and a content item including, for example, ordered play lists, libraries of content items that have selected by the user and/or suggested for the user by other users, the content provider system, etc.; bookmarked content items that are manually marked (e.g., by the user) or flagged by the content provider service, etc. When a particular content item is removed form the digital content library, user play lists may become partially, or completely, inoperative. To address this problem, various example embodiments comprise systems and methods for updating user play lists. When a content item is to be removed from the digital content library, a computer system (e.g., a computer system associated with the content provider service) identifies user play lists that reference the content item. References in the user play lists to the removed content item are subsequently replaced with references to an equivalent content item. The equivalent content item may be determined in any suitable manner including, for example, those described herein.

In some example embodiments, it is not efficient to replace references to all content items that are to be deleted from the digital content library. For example, some content items may be very seldom accessed by users. According, the computer system may update user play lists only for content items have a predetermined level of usage. For example, the computer system may omit from consideration content items that are provided to users at less that a threshold frequency over a certain period of time (e.g., the last three months, the last year, etc.).

In some example embodiments, identified equivalent audio tracks or other content items may be utilized to implement logical content item requests. For example, a user (through a user device) may request a first content item. A computer system (e.g., a computer system associated with the content provider service) receives the request and translates the first content item to a logical name. The logical name may refer to subject matter of the content item and not the physical content item itself. Therefore, the logical name can refer to multiple equivalent content items. Based on the logical name, the computer system may select a content item and return it to the user, either directly or via a content distribution system as described herein. The requested content item and the returned content item may be logically equivalent, but need not be the same content item.

Reference will now be made in detail to several example embodiments, examples of which are illustrated in the accompanying figures. Wherever practicable, similar or like reference numbers may be used in the figures and may indicate similar or like functionality. The figures depict example embodiments of the disclosed systems (or methods) for purposes of illustration only. One skilled in the art will readily recognize from the following description that alternative example embodiments of the structures and methods illustrated herein may be employed without departing from the principles described herein.

FIG. 1 is a block diagram showing one example embodiment of an environment 100 for implementing systems and methods for identifying equivalent content items and/or updating content items provided to users. The environment 100 comprises one or more playback systems 110, one or more rights holder systems 112, one or more content distribution systems 104, one or more outside information systems 113, and a plurality of user devices 102. Each user device 102 may be associated with a user 103. For example, a user 103 may own, lease, or otherwise have rights to use his or her associated user device 102. The user devices 102 may receive various content items and/or user interfaces from and/or through other systems 104, 110, 112 of the environment 100 and provide the content items to the associated user 103, for example, as described herein. User devices 102 may comprise any type of network-enabled computer device that may be utilized by a user to receive and/or view content items. Examples of user devices include smart phones, tablet computers, laptop computers, desktop computers, network-enabled stereo receivers, etc. In some example embodiments, each user 103 is associated with a subscription account to one or more content provider services. It will be appreciated, however, that subscription accounts may be associated with user devices 102 in addition or instead of being associated with users 103. In some example embodiments, subscription accounts may be associated with a geographic location or area, for example, the primary geographic location or area from which the user 103 and/or user device 102 contacts the playback system 110, as described herein.

Content provider services may be embodied by one or more playback systems 110, which may operate in conjunction with one or more content distribution systems 104. The playback system 110 may receive a request for a content item from a user 103 (e.g., via a user interface). In response to such a request, the playback system 110 may authenticate the user 103 and/or associated user device 102 to determine that the user 103 and/or the user device 102 has an active subscription that entitles the user 103 (and/or device 102) to access the requested content item. Provided that the authentication is successful, the playback system 110 may cause the requested content item to be provided to a user device 102 associated with the requesting user 103. For example, the playback system 110 may request that the content item be transmitted to the user device 102 by a content distribution system 104. Content items may be transmitted from a content distribution system 104 to a user device 102 in any suitable manner. For example, the content items may be transmitted via a secure communication channel formed between the content distribution system 104 and the user device 102 such as a transport layer security (TLS) or secure socket layer (SSL) channel. Also, for example, some content items may be individually encrypted during communication or transmitted in the clear. It will also be appreciated that content items may be provided to user devices 102 as discrete files or units or as part of a stream of content.

The playback system 110 may be programmed to implement various tools allowing users 103 to search available content items provided via a user interface. Examples of such tools may include search engines, play lists and radio stations. Search engines allow users 103 to locate content items according to any suitable searching methodology such as, for example, key word searches, searches by genre, searches by content item type, etc. Play lists may be lists of content items, for example, stored at playback systems 110. A play list may be created automatically, created by editorial staff of the content service provider and/or created based on input from a user device 102. Play lists may be available to all users 103, only to originating users 103, to select users 103, etc. In some example embodiments, users 103 have associated user play lists. User play lists can be ordered play lists that the user 103 generated and/or selected to be associated with the user's account. User play lists may also include any other content items associated with a user. In some example embodiments, user play lists may be selected and associated with a user's account automatically (e.g., by the playback system 110). A radio station may comprise a flow of content items generated, for example, by a playback system 110 and, for example, streamed to one or more users. The content items making up a radio station flow may be repeated and/or continuously updated (e.g., by the playback system 110). Specific content items may be included in a radio station flow or may be selected based on one or more common characteristics (e.g., similarity to a set of user selected content items, a common genre, a common artist, a common theme, etc.). In addition to indications of content items, user play lists may also include indications of radio station flows.

In some example embodiments, the playback system 110 comprises a data store 109 comprising play back data. The playback data may include some or all of the content items that may be provided to users 103. For example, in some example embodiments, the playback system 110 partially or completely provides the content items directly to the users 103 thus replacing some or all of the functionality of the content distribution systems 104. The data store 109 may also comprise a user database that includes data describing various users 103 including, for example, user play lists associated with users.

The content distribution systems 104 may comprise one or more data stores 108 comprising content items and a server or other computer device 106 for processing requests. In various example embodiments, the playback system 110 utilizes multiple distributed content distribution systems 104 as shown. Some or all of the content distribution systems 104 may be mirrors of one another located at disparate geographic and/or network locations. For example, the playback system 110 may balance the loads of various content distribution systems 104 by directing requests to transmit content items to different content distribution systems 104 based on geographic and/or network proximity between the requesting user device 102 and the various content distribution systems 104, loads on the content distribution systems 104, etc. In some example embodiments, the content distribution systems 104 may be operated by a third-party vendor of the content provider service such as, for example, LIMELIGHT NETWORKS. For example, the third-party vendor or associated system may perform the load balancing described herein above.

In some example embodiments, the environment 100 also comprises one or more rights holder systems 112. Rights holder systems 112 may be associated with entities that hold the rights (e.g., copyright, trademark, etc.) in content items making up the digital content library. Rights holder systems 112 may provide digital content items to the playback system 110 and/or content distribution system(s) 104. In some example embodiments, rights holder systems 112 also indicate to the playback system 110 digital content that is to be removed from the digital content library including, for example, digital content items for which license rights have expired, digital content items that are being re-released in another form, etc.

Also, in some example embodiments, the environment 100 comprises one or more outside information systems 113. Outside information systems 113 may be any type of system that provides information to the playback system 110 or other systems for performing the various functionalities described herein. In some example embodiments, the outside information systems 113 may include digital fingerprinting service such as, GRACENOTE, INC., THE ECHONEST, etc.

The various components 102, 104, 110, 112, 113, etc. of the environment 100 may communicate with one another via a network 116. The network 116 may be any suitable type of wired, wireless, or mixed network and may comprise, for example, the Internet, a local area network (LAN), a wide area network (WAN), etc. In some example embodiments, some or all of the functionality for implementing a content provider service may be consolidated in a single system. For example, any combination of the playback system 110 and/or the various content distribution systems 104 may be consolidated into one or more single systems (e.g., at a common geographic location).

FIG. 2 is a block diagram showing one example embodiment of a playback system 110 in communication with a user device 102 and a content distribution system 104. The playback system 110 is programmed to execute example functional modules 118, 120, 122, 124. A grouping module 124 may generate groups comprising two or more equivalent content items, for example, as described herein. A communication module 118 may be programmed to facilitate communication between the playback system 110 and various other components of a content provider service such as, for example, content distribution systems 104, outside information systems 113, rights holder systems 112, etc. A user interface module 120 is programmed to generate a user interface 128 and provide the interface 128 to users 103 (e.g., via the associated user devices 102). The interface 128 may provide the users 103 with indications of available content items. In some example embodiments, the interface 128 provides the users 103 with indications of user play lists from which the users may select content items for streaming and/or download. The user 103 may select one or more content items, for example, via selections 124 made through the user interface 128. In response, the playback system 110 may initiate the provision of the selected content items 132 to the user device 102. A content distribution module 122 may facilitate the distribution of the selected content items. For example, the content distribution module 122 may instruct at least one of the content distribution systems 104 to provide the content items 132 to the user 103 (e.g., via the communication module 118). Also, in some example embodiments, the content distribution module 122 is programmed to distribute content items 132 directly from the playback data store 109 to the user 103.

In some example embodiments, the playback data store 109 comprises various databases 134, 136 comprising data used by the playback system 110. A user database 136 comprises various data describing users of the content provider service implementing the playback system 110. Such data may include, for example, account data, log-in information, usage logs, etc. In various example embodiments, the user data stored at the user database 136 also comprises user play lists including user play list generated by a user 103, provided to the user 103 by another user 103, assigned to the user by the content provider service, etc. A master database 134 may comprise various data for executing and managing the content provider service. For example, groups of two or more equivalent content items may be found and indications thereof stored at the master database, as described herein below. The various data and databases described herein as being stored on the playback data store 109 may be implemented on a single storage device, or across multiple storage devices. Also, in some example embodiments, the master database 134 and/or user database 136 may be implemented as sub-sets of other databases comprising other related or unrelated data.

The example user device 102 shown in FIG. 2 comprises a client 133, an optional user play list 134 and optional local tracks 136. The client 133 may facilitate communications with the playback system 110. For example, the client 133 may receive and display the user interface 128 from the playback system 110 and receive and transmit interface selection 126 from the user 103. In some example embodiments, the user device 102 may comprise locally stored user play lists 134. The playback system 110 may provide play list updates 130 for updating locally stored user play lists 134, for example, as described herein.

FIG. 3 is a block diagram showing one example embodiment of the master database 134. As illustrated in FIG. 3, the master database 134 comprises content item records 302, comparison records 304, and content item groups 304. Content item records 302 may indicate content items that are related to the digital content library. This may include, for example, content items that are part of the digital content library, content items that are to be incorporated into the digital content library, content items that are or have been deleted from the digital content library, a location of respective content items, etc. For example, when the playback system 110 receives a request to provide a content item, it may refer to the content item records to locate the content item and/or determine if it is available in the digital library.

Comparison records 304 may indicate results of comparisons between content item characteristics. For example, comparison records 304 may include comparison words derived as described herein. Content item groups 306 may indicate equivalent content items determined, for example, as described herein. Content item groups 306 may be expressed as lists of equivalent content items and/or as replacement tables indicating equivalent content items that may replace other content items. FIG. 4 is a block diagram showing one example embodiment of the user database 136. The user database 136 may comprise user records 402, with each record corresponding to a user of the content provider service. The user records 402 may indicate various information about users including, for example, user play lists, user account information, log-in credentials, etc.

In various example embodiments, the playback system 110 (e.g., the grouping module 124 thereof) may group equivalent content items. FIG. 5 is a flow chart showing one example embodiment of a process flow 500 that may be performed by the playback system 110 (e.g., the grouping module 124 thereof) to group equivalent content items. At 502, the grouping module 124 may receive an indication of content items to be grouped. In some example embodiments, the content items to be grouped are a set of content items to be grouped primarily with one another, for example, as part of a new digital content library or a subcomponent of an existing library. In some example embodiments, the content items to be grouped are new content items to be added to a previously-grouped library or subcomponent thereof.

At 504, the grouping module 124 may compare a first content item of the group to each of a set of other content items. The set of other content items may comprise, for example, other content items from the group and/or a set of previously-grouped content items. Each comparison between the first content item and one of the set of other content items may comprise comparing a set of content item characteristics describing the first content item and a set of content item characteristics describing the one of the set of other content items. At 506, the grouping module 124 may determine whether there are additional content items from the content items to be grouped. If so, the comparison of 504 may be repeated for the next content item. When there are no additional content items to be compared, the grouping module 124 may make and/or update associations based on the comparisons from 504. For example, content items having a predetermined pattern of equivalent characteristics may grouped as equivalents. The set of content item characteristics utilized for the comparison may include any suitable characteristics. Characteristics may be generally-applicable, or specific to a particular type of content item. Example content item characteristics include digital fingerprint values, content item names, an artist or artists associated with the content item, a live flag value, an explicit flag value, a hash value, a duration, a disk number, a sequence number, etc. In some example embodiments, there may be more than one predetermined pattern of equivalent characteristics that indicate overall content item equivalence. For example, content items having equivalent digital fingerprints may be considered equivalent regardless of other characteristics. Other combinations of content item characteristics that may indicate overall content item equivalence are illustrated in Table 1 below:

TABLE 1
Example Patterns of Content Item Characteristics Indicating Equivalence

digital finger print
content item name, artist and album
content item name, artist, live flag, and explicit flag
hash value

A digital fingerprint for a content item is typically obtained by performing a calculation on the content item. The value of a digital fingerprint depends on the binary values comprising the digital content item. The playback system 110 or other system of the content provider service may obtain digital fingerprints by applying a digital fingerprinting algorithm to content items and/or by obtaining digital fingerprint values from service, such as those available from GRACENOTE, INC. and THE ECHONEST. Comparisons between digital fingerprints may be performed by applying a comparison algorithm to the fingerprints. In some example embodiments, the comparison algorithm is executed by the grouping module 124 or other component of the content provider service. Also, in some example embodiments, the comparison algorithm is proprietary. For example, digital fingerprints may be sent to the third party service that, in turn, provides a result of the comparison. Digital fingerprints may be considered equivalent according to any suitable criteria, which may depend on the type of digital fingerprint and/or comparison algorithm used. For example, in some example embodiments, the result of the comparison algorithm is binary indicating equivalence or no equivalence between the fingerprints. Also, in some example embodiments, the result of the comparison algorithm indicates a degree of correlation between the fingerprints (and/or the underlying content items). Digital fingerprints may be considered equivalent if the degree of correlation exceeds a predetermined threshold.

A content item name characteristic describes the name or title of the content item. In the context of an audio track content item, this could be the name of the audio track. In various example embodiments, the name of a content item is represented as a text string. Accordingly, a text compare function may be utilized to compare the names of different content items. The grouping module 124 may consider there to be a match between content item names if the corresponding text strings are identical and/or if the corresponding text strings differ by less than a predetermined amount (e.g., two characters). In some example embodiments, the grouping module 124 performs various text formatting before comparing two content items names. Text formatting may comprise converting content item names to a common format indicating, for example, standardizing capitalization, removing excess spaces or other non-alphanumeric characters, etc.

An associated artist characteristic may described one or more artists associated with the creation of and/or performance on a content item. When the content item is a music track, the artist may correspond to the performer who created the music track. Content items that are not music tracks may also have associated artists. For example, movies may have directors, actors, producers, etc. Images may have photographers, illustrators, etc. Artists for different content items may be compared utilizing the text string method described above with respect to content item names. In some example embodiments, including music tracks, artists may be described by unique (e.g., alphanumeric) codes, simplifying comparisons. When artists are represented by a text string, the grouping module 124 may consider there to be a match between content item artists if the corresponding text strings differ by less than a predetermined amount. When artists are represented by a unique code, the grouping module 124 may consider there to be a match between content item artists if the unique codes match.

An album characteristic may describe audio track content items by indicating an album or collection of songs to which the audio track belongs. Album characteristics may be expressed as a text string and/or unique code. Comparing album characteristics for two audio tracks may comprise either a text string comparison, similar to those described above, or a straight comparison between codes. An explicit flag characteristic may indicate whether a content item has a title and/or content that is explicit and/or profane. In some example embodiments, the explicit flag characteristic for a content item is set by the playback system 110. For example, the playback system 110 may implement an algorithm that reviews the title and/or lyrics of an audio track or other content item to determine whether any explicit content is included. Also, in some example embodiments, content items are received from a rights holder system 112 already flagged as to whether they include explicit content. In some example embodiments, an explicit flag is binary. Explicit flag characteristic values for content items are equivalent if those values are the same.

A live flag characteristic may be set, for example, for an audio track, if the audio track was recorded live (as opposed to being recorded in a studio). The live flag value for a content item may be received, for example, from the rights holder system 112. In some example embodiments, the playback system 110 may determine the correct value for a content item's live flag, for example, by reviewing text associated with the content item for indications of the word “live” and/or other indications of a live recording. A live flag may be binary, meaning that two tracks may have equivalent values for a live flag characteristic if those values are equal. A hash characteristic for a digital content item is obtained by applying a hash algorithm to the digital content item. The hash algorithm may return a value that is theoretically unique for each digital content item. Unlike a digital fingerprinting algorithm, it may not be possible to determine a degree of correlation between hash values that are not identical. Accordingly, hash characteristics between two content items may be considered equivalent only when the hash values are identical. Any suitable hash value may be used including, for example, an MD5 Message-Digest algorithm.

A content item duration characteristic describes the play time of the content item and may be applied to audio track content items as well as video content items. Content items may be considered to have equivalent durations if the durations different by less than a predetermined threshold (e.g., 2 seconds). A disk number characteristic describes the disk or other tangible media associated with a content item. For example, in the context of an audio track, the disk number may describe the disk of an album on which the audio track appeared (e.g., disk 1 or disk 2). Disk number characteristics between content items may be considered equivalent if they are identical. A track sequence characteristic describes the ordering of a content item among other content items (e.g., on an album). Track sequence characteristics, in various example embodiments, are applied to audio tracks. For example, the first track on an album may have a sequence number of one, the second track a sequence number of two, and so on. Track sequence characteristics between different content items may be considered equivalent if they are identical.

As described above with respect to FIG. 5, identifying equivalent digital content items may involve comparing a first content item (e.g., a subject content item) to a group of other content items based on associated content item characteristics (e.g., those described above). FIG. 6 is a flow chart showing one example embodiment of a process flow 600 that may be performed by the playback system (e.g., the grouping module 124) to compare content items in this way based on their associated characteristics. In the process flow 600, actions 601 relate to a comparison between a subject content item and a content item selected from the group of other content items. At 602, the grouping module 124 may compare values for a first characteristic of the subject content item and a first content item selected from the group of other content items. At 604, the grouping module 124 may determine whether the characteristic values are equivalent. Results may be recorded at 606. In some example embodiments, the results may be recorded by setting bits in a digital comparison word or words. The number of bits used may correspond to the number of characteristics to be compared. For example, if the first characteristics of the subject content item and the first content item are equivalent, then a first bit of the word may be set.

At 608, the grouping module 124 may compare values for a second characteristic of the subject content item and the first content item. Depending on whether the values are equivalent at 610, the grouping module 124 may set the second bit of the comparison word appropriately at 612. Similarly, the grouping module 124 may compare values for a third characteristic of the subject content item and the first content item at 614. Depending on whether the values are equivalent at 610, the grouping module 124 may set the third bit of the comparison word appropriately at 618. The process 601 may be completed for any suitable number of compared characteristics. An n^{th} characteristic may be compared at 620, with the n^{th} bit of the comparison word set appropriately at 624 if there is a match at 622. After characteristics of the subject content item and the first content item are compared at 601, the grouping module 124 may consider at 626 whether the first content item is the last track of the group of other content items (i.e., whether there are additional content items in the group of other content items that have not yet been compared to the subject content item.) If additional content items remain, the grouping module 124 may increment to the next content item in the group of other content items and repeat the comparison actions 601.

Results of the comparison described in FIG. 6 may be, for each combination of the subject content item and one of the group of other content items, a list of characteristics, if any, that are equivalent. As described above, the list may be represented as a comparison word. FIG. 7 is a diagram showing one example embodiment of a comparison word 700 indicating results of a comparison between a first content item (Track A) and a second content item (Track B). Column 702 includes an indication a characteristic corresponding to each bit of the comparison word. Column 704 indicates an equivalence value corresponding to each characteristic. In FIG. 7, a logical one “1” corresponds to equivalence between the characteristics while a logical zero “0” corresponds to a lack of equivalence between the characteristics. Example patterns indicating overall content item equivalence are provided above in TABLE 1.

FIG. 8 is a flow chart showing one example embodiment of a process flow 800 that may be performed by the playback system 110 to compare a set of content items to be grouped (a set of subject content items) to a set of other content items. As described herein, the set of other content items may include content items that have already been grouped and/or all or a portion of the set of subject content items. At 802, the grouping module 124 may load the set of subject content items. In some example embodiments, the set of subject content items is a set of content items to be added to the digital content library and is received from a rights holder system 112. At 804, the grouping module 124 may select from the set of subject content items a next subject content item for grouping. At 806, the grouping module 124 may determine whether the next subject content item is already matched with one or more content items from the set of other content items. If yes, the grouping module 124 may determine, at 828, whether the next subject content item is the last content item in the set of subject content items. If not, then the grouping module may proceed again to 804 and select a new next subject content item.

When the next subject content item has not yet been matched, the grouping module 124 may compare the next subject content item to the set of other content items at 808. In various example embodiments, the comparison may proceed in a manner similar to that described herein with respect to the process flow 600. For example, the result of the comparison may be a set of comparison words (e.g., as illustrated in FIG. 7) for each combination of the next subject content item and one of the set of other content items.

When the next subject content item has been compared to each of the set of other content items, the grouping module 124 may, at 812, filter combinations of the next content item and the other content items based one or more predetermined patterns of equivalent characteristics. For example, each comparison of the next subject content item to one of the set of other content items may have resulted in a comparison word indicating the characteristics that the respective content items have in common. The comparison words may be stored at the master database 134. The grouping module 124 may filter the combinations by analyzing each of the comparison words (or other records of the comparison) and selecting combinations that have at least one predetermined pattern of equivalent characteristics that indicate equivalence between the content items. The predetermined pattern of characteristics may be selected in any suitable manner. Example patterns are indicated in TABLE 1 above, although it will be appreciated that alternate patterns may be used in addition to or instead of those shown at TABLE 1.

If any content item combinations (e.g., comparison words) remain after 812, the grouping module 124 may determine, at 816, if the corresponding content items (e.g., the next subject content item and one of the set of other content items) are part of an existing group of equivalent content items. If so, the grouping module 124 may determine, at 824, whether the corresponding content items are part of more than one existing group. If so, the content items may be reported to a human editorial staff for review, at 826, and the process may proceed to 828, as described above. If the corresponding content items are not part of more than one group, then the grouping module may get the existing group identification and update a logical content item group record (e.g., at the master database 134). If at 816 the corresponding content items are not part of a preexisting group, then the grouping module 124 may create a new content item group at 818 and similarly update the logical content item grouping at 820. In this way, the master database 134 may include an indication of a logically equivalent group of content items comprising at least the next content item and any other content items from the set of other content items which are equivalent to the next subject content item.

Referring back to 828, if the next subject content item is the last subject content item, the grouping module may update the content item group record at 830 to reflect the inclusion of the set of subject content items. At 831, the grouping module may update a list of not-matched content items (e.g., at the master database 134). The list of not-matched content items may comprise content items that have not been found to be equivalent to any other content items. Optionally, at 832, the grouping module 124 may update a replacement table. The replacement table may also be stored at the master database 134 and may indicate equivalent content items that are suitable replacements for one another.

In various example embodiments groups of equivalent content items (e.g., audio tracks) may be utilized to update user play lists. For example, a content item removed from the digital content library may no longer be available to users for download. The content item may be indicated at the content item records 302 as no longer available and/or removed from the playback data store 109 and/or the content distribution system or systems 104. User play lists, however may still include references to the removed content item. FIG. 9 is a flow chart illustrating a process flow 900 that may be performed by the playback system 110 (e.g., the content distribution module 122) to update user play lists to reflect changes to available content items. At 902, the content distribution module 122 may select content items for replacement. The selected content items may be content items that either have been recently removed from the digital content library or are slated for removal. At 904, the content distribution module 122 may refresh the user database 904. This involves updating the user database 134 to capture any changes to user play lists that, for example, are stored at user devices 102 but not reflected in the user database 136.

At 906, the content distribution module 122 examines some or all of the user play lists stored at the user database 136 to identify references to content items from the selected content items for replacement. At 908, the content distribution module 122 may get the next content item for replacement. At 910, the content distribution module 122 may determine whether there is a content item that is the equivalent of the next content item for replacement. For example, the content distribution module 122 may consult the content item groups and/or replacement tables generated, as described herein. If an equivalent content item exists, the content distribution module 122 may update each user play list comprising a reference to the next content item to point to the equivalent content item instead. The updates may be audited at 914. If the next content item is not the last content item for replacement, then the content distribution module 122 may get a new next track for replacement at 908.

In some example embodiments, the existence and/or identity of an equivalent content item may depend on a geographic area associated with specific users. For example, a content item A may be equivalent to a content item B and a content item C. Content item A may be for distribution across geographic areas. Content items B and C, however, may be distribution only in limited geographic areas. Accordingly, content item A is to be replaced in user play lists, play lists in the geographic area for content item B may be updated to reference content item B, while those in the geographic area for content item C may be updated to reference content item C.

FIG. 10 is a flow chart illustrating one example embodiment of a process flow 1000 that may be performed by the playback system 110 (e.g., the content distribution module 122 thereof) to update user play lists to reflect changes to available content items. In FIG. 10, at 1002, the content distribution module 122 first updates the user database 134 as described herein above at 904. At 1004, the content distribution module 122 receives an indication of content items that are to be taken down (TBTD) from the digital content library. In various example embodiments, the content distribution module 122 may additional receive an indication of the frequency at which the content items to be taking down are provided to users of the content provider service. At 1006, the content distribution module 122 may select content items for replacement. The selection at 1006 may be based both on the content items that are to be taken down and on the content of the user play lists. For example, the content items for replacement may include content items that are referenced in at least one user play list and are provided to users at greater than a threshold frequency. For example, if a content item to be taken down is provided to customers at less than the threshold frequency, then the playback system 110 may not update user play lists that include references to the content item, thereby economizing processing power. Upon selection of the content items for replacement, the content distribution module 122 may execute the replacement at 908, 910, 912, 914, 916, for example, as described herein above.

FIG. 11 is a flow chart illustrating one example embodiment of a process flow 1100 that may be performed by the playback system 110 (e.g., the content distribution module 122 thereof) to update user play lists stored at user devices 102. At 1102, the playback system 110 receives a request from a user device 102 to log-into the playback system 110. For example, the playback system 110 may authenticate the user device 102 and/or a user 103 thereof as described herein. At 1104, the playback system 110 may determine if there have been changes to any locally stored user play lists of the user 103. For example, the playback system 110 may determine whether any of the user's play lists stored at the user database 136 have changed. The playback system 110 may then query the user device 102 to determine which, if any, of the affected user play lists are stored locally at the user device 102. In some example embodiments, user play lists at the user database 136 may be stored when an indication of whether the respective play lists are stored locally.

If there have been changes to a locally-stored user play list at 1104, then the playback system 110 may update the locally-stored user play list or play lists at 1110. For example, the playback system 110 may push to the user device 102 replacement user play lists and/or indications of play list updates that may be implemented by the user device 102 (e.g., the client 133 thereof). The updates may indicate replaced content items and corresponding equivalent content items. In some example embodiments, the replaced content items are content items that are no longer part of the content provider service's digital library, as described herein. At 1106, the playback system 110 (e.g., the content distribution module 122, and user interface module 120 thereof) may receive from the user device 102 a request for a content item, identified by a content item identifier or ID. The request may be made from an updated user play list and the content item ID may refer to an equivalent content item added to the play list 1110. At 1108, the playback system 110 may provide the requested content item to the requesting user device 102 (or user 103 thereof). For example, the content distribution module 122 may request that a content distribution system 104 stream the content item to the user device 102.

In some example embodiments, content provider services may eliminate the need to update user play lists by identifying content items according to logical rather than item-specific identifiers. FIG. 12 is a flow chart illustrating one example embodiment of a process flow 1200 that may be performed by the playback system 110 to respond to a content item request utilizing logical content item identifiers. At 1202, a user device 102 (and/or user 103 thereof) logs-in to the playback system 110, for example, as described herein. At 1204, the playback system 110 (e.g., the user interface module 120 and/or the content distribution module 122) receives a request for a content item. Instead of specifying a particular content item ID, the request may indicate a logical content item name (e.g., a name that refers to multiple, equivalent content items). At 1206, the content distribution module 122 may provide the requested content item. For example, the logical name may correspond to a group of equivalent content items (e.g., one of the content item groups 306 stored at the data store 109). The content distribution module 1220 may provide a content item selected from the group 306. Because content item requests in this configuration refer to logical groups of content items rather than individual content items, it may not be necessary to update user play lists when individual content items become unavailable.

In some example embodiments, the need to update user play lists may also be obviated by having the playback system 110 translate requested content item ID's into new ID's corresponding to equivalent content items. For example, when a content item is removed from the digital library, that content item's unique ID may continued to be stored in conjunction with ID's for other equivalent content items (e.g., at group storage 306). When a user device 102 (or user 103 thereof) submits a content item request including the content item ID of a removed content item, the playback system 110 (e.g., the content distribution module 122 thereof) refers to the group storage 306 to identify an equivalent content item, and then provides the equivalent content item to the requesting user device 102. FIG. 13 is a flow chart illustrating one example embodiment of a process flow 1300 that may be performed by the playback system 110 to translate content item ID's in this manner. At 1302, the playback system 110 logs a user device 102 (and/or a user 103 thereof) in to the playback system 110, for example, as described above. At 1304, the playback system 110 (e.g., the user interface module 120 or content distribution module 122 thereof) receives from the user device 102 a request for a content item, where the requested content item is referenced by content item ID. The content item ID may refer to a content item that is not available as part of the digital content library. At 1305, the playback system 110 translates the received content item ID into a content item ID associated with an equivalent content item. The translation may be performed in any suitable manner. For example, at 1306, the playback system 110 may translate the content item ID into an indication of a logical group (e.g., a logical group stored at group storage 306). At 1308, the playback system 110 identifies an alternate content item (e.g., alternate content item ID) referring to a content item that is equivalent to the requested content item. At 1310, the playback system 110 may provide the user device 102 with the alternate content item.

Various example embodiments will be described herein in the context of content items that are audio tracks. It will be appreciated, however, that the systems and methods described herein may be utilized generally to identify equivalent content items of other types, such as video content items, image content items, etc.

The features and advantages described in the specification are not all inclusive and, in particular, many additional features and advantages will be apparent to one of ordinary skill in the art in view of the drawings, specification, and claims. The language used in the specification has been principally selected for readability and instructional purposes, and may not have been selected to delineate or circumscribe the disclosed subject matter.

The figures and the following description relate to example embodiments of the invention by way of illustration only. Alternative example embodiments of the structures and methods disclosed here may be employed without departing from the principles of what is claimed.

Any patent, publication, or other disclosure material, in whole or in part, that is said to be incorporated by reference herein is incorporated herein only to the extent that the incorporated materials do not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

Reference in the specification to “one example embodiment,” “various example embodiments,” or to “an example embodiment” means that a particular feature, structure, or characteristic described in connection with the example embodiments is included in at least one example embodiment of the invention. The appearances of the phrase “in one example embodiment” or “a preferred example embodiment” in various places in the specification are not necessarily all referring to the same example embodiment. Reference to example embodiments is intended to disclose examples, rather than limit the claimed invention.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of actions (instructions) leading to a desired result. The actions are those requiring physical manipulations of physical quantities. Usually, though not necessarily, these quantities take the form of electrical, magnetic or optical signals capable of being stored, transferred, combined, compared and otherwise manipulated. It is convenient, at times, principally for reasons of common usage, to refer to these signals as bits, values, elements, symbols, characters, terms, numbers, or the like. Furthermore, it is also convenient, at times, to refer to certain arrangements of actions requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers and computer systems referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method actions. The required structure for a variety of these systems will appear from the above description. In addition, the present invention is not described with reference to any particular programming language. It will be appreciated that a variety of programming languages may be used to implement the teachings of the present invention as described herein, and any references above to specific languages are provided for disclosure of enablement and best mode of the present invention.

While the invention has been particularly shown and described with reference to a preferred example embodiment and several alternate example embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A system for updating user play lists in a content provider service, the system comprising:
a computer system comprising at least one processor and operatively associated memory, wherein the computer system is programmed to:
receive indications of a plurality of content items to be removed from a digital content library of the content provider service;
query a user database to identify a plurality of user play lists comprising a reference to a first content item selected from the plurality of content items, wherein each of the plurality of user play lists is associated with a user of the content provider service;
identify a second content item that is equivalent to the first content item; and
update at least one user play list selected from the plurality of user play lists to replace references to the first content item with references to the second content item.

2. The system of claim 1, wherein the computer system is further programmed to:
query the user database to identify a plurality of user play lists comprising a reference to a third content item selected from the plurality of content items;
identify a fourth content item that is equivalent to the third content item; and
update at least one user play list selected from the second plurality of user play lists to replace reference to the third content item with a reference to a fourth content item.

3. The system of claim 1, wherein the computer system is further programmed to, before identifying the at least one content item:
receive an indication of the frequency at which at least a portion of the plurality of content items is provided to users of the content provider service; and
based on the indication, remove from the plurality of content items at least one content item that is provided to users of the content provider service at below a threshold frequency.

4. The system of claim 1, wherein the computer system is further programmed to:
receive from a user device a request to log-in to the content provider service on behalf of a first user; and
in response to the request, push to the user device an update to a user play list associated with the first user.

5. The system of claim 4, wherein the computer system is further programmed to query the user device to determine whether a version of the user play list associated with the first user and stored at the user device is updated, and wherein the pushing is executed when the version of the user play list is not updated.

6. The system of claim 1, wherein the computer system is further programmed to remove the plurality of content items from the digital content library of the content service provider.

7. The system of claim 1, wherein the computer system is further programmed to create an audit log for each of the plurality of user play lists, wherein the audit log for each user play list indicates the updating.

8. The system of claim 1, wherein the second content item is equivalent to the first content item for user play lists corresponding to users associated with a first geographic area, and wherein the computer system is further programmed to:
select from the plurality of user play lists, a user play list set comprising at least one user play list associated with users in a second geographic area;
identify a fifth content item that is equivalent to the first content item for user play lists corresponding to users associated with the second geographic area; and
update the user play list set to replace references to the first content item with references to the fifth content item.

9. A computer-implemented method for updating user play lists in a content provider service, the method comprising:
receiving, by a computer system, indications of a plurality of content items to be removed from a digital content library of the content provider service, wherein the computer system comprises at least one processor and operatively associated memory;
querying a user database, by the computer system, to identify a plurality of user play lists comprising a reference to a first content item selected from the plurality of content items, wherein each of the plurality of user play lists is associated with a user of the content provider service;
identifying, by the computer system, a second content item that is equivalent to the first content item; and
updating, by the computer system, at least one user play list selected from the plurality of user play lists to replace references to the first content item with references to the second content item.

10. The method of claim 9, further comprising, before identifying the at least one content item:
receiving, by the computer system, an indication of the frequency at which at least a portion of the plurality of content items is provided to users of the content provider service;
based on the indication, removing, by the computer system, from the plurality of content items at least one content item that is provided to users of the content provider service at below a threshold frequency.

11. The method of claim 9, further comprising:
receiving, by the computer system and from a user device, a request to log-in to the content provider service on behalf of a first user; and
in response to the request, pushing, by the computer system and to the user device, an update to a user play list associated with the first user.

12. The method of claim 11, further comprising querying the user device, by the computer system, to determine whether a version of the user play list associated with the first user and stored at the user device is updated, and wherein the pushing is executed when the version of the user play list is not updated.

13. The method of claim 9, further comprising removing, by computer system, the plurality of content items from the digital content library of the content service provider.

14. The method of claim 9, further comprising creating, by the computer system, an audit log for each of the plurality of user play lists, wherein the audit log for each user play list indicates the updating.

15. The method of claim 9, wherein the second content item is equivalent to the first content item for user play lists corresponding to users associated with a first geographic area, and further comprising:
selecting, by the computer system, from the plurality of user play lists, a user play list set comprising at least one user play list associated with users in a second geographic area;
identifying, by the computer system, a fifth content item that is equivalent to the first content item for user play lists corresponding to users associated with the second geographic area; and
updating, by the computer system, the user play list set to replace references to the first content item with references to the fifth content item.

16. A system for updating content items provided to users by a content provider service, the system comprising:
a computer system comprising at least one processor and operatively associated memory, wherein the computer system is programmed to:
receive from a user device a request for a first content item, wherein the request indicates the first content item;
translate the indication of the content item to a logical name, wherein the logical name is associated with at least one content item that is equivalent to the first content item;
select a second content item from the at least one content item that is equivalent to the first content item; and
in response to the request, cause the second content item to be provided to the user device.

17. The system of claim 16, wherein causing the second content item to be provided to the user device comprises transmitting the second content item to the user device.

18. The system of claim 16, wherein causing the second content item to be provided to the user device comprises instructing a distributed storage service to provide the second content item to the user device.

19. The system of claim 16, wherein the second content item is selected from the at least one content item considering a geographic area associated with a user of the user device.

20. A computer-implemented method for updating content items provided to users by a content provider service, the method comprising:
receiving, by a computer system and from a user device, a request for a first content item, wherein the request indicates the first content item, wherein the computer system comprises at least one processor and operatively associated memory;
translating, by the computer system, the indication of the content item to a logical name, wherein the logical name is associated with at least one content item that is equivalent to the first content item;
selecting, by the computer system, a second content item from the at least one content item that is equivalent to the first content item; and
in response to the request, causing, by the computer system, the second content item to be provided to the user device.
